(19) United States
(12) Patent Application Publication
(10) Pub. No.: US 2007/0042923 A1
(43) Pub. Date: Feb. 22, 2007

(54) Laundry cleaning delivery system

(76) Inventors: Akos Jankura, St. Petersburg, FL (US); William Barlow JR., St. Petersburg, FL (US)

Correspondence Address: MORRISON & FOERSTER LLP, 1650 TYSONS BOULEVARD, SUITE 300, MCLEAN, VA, 22102, US

(21) Appl. No.: 11/483,191

(22) Filed: Jul. 10, 2006

Related U.S. Application Data
(60) Provisional application No. 60/697,356, filed on Jul. 8, 2005.

(51) Int. Cl. C11D 17/00

(52) U.S. Cl. 510/295; 510/514; 510/438

(57) ABSTRACT

A laundry cleaning delivery system that dispenses cleaning liquid into laundry machines is disclosed. A cleaning solution is impregnated into a sheet that has a fabric substrate sufficient to contain the correct amount of cleaning solution to clean a particular load of laundry. The fabric substrate comprises hydraulically entangled nonwoven fibrous material periodically perforated to create sheets of a desired size and roll count and wound into rolls that are placed into resealable containers. The active ingredients of the cleaning solution comprise amyl acetate and alcohol etoxylate. Also, methods of using and manufacturing a laundry cleaning delivery system are disclosed herein.

### CROSS-REFERENCE TO RELATED APPLICATIONS

This application claims the priority of U.S. Provisional Application No. 60/697,356, filed Jul. 8, 2005, the disclosure of which is hereby incorporated by reference in its entirety.

### BACKGROUND OF THE INVENTION

1. Field of the Invention

The invention relates to a laundry cleaning delivery system, and, more particularly, to a laundry cleaning delivery system that uses sheets impregnated with a cleaning solution.

2. Description of Related Art

Traditional laundry cleaning methods using a washing machine require powder or liquid detergent to wash clothes. These methods usually require measuring an amount of detergent and may create a considerable mess, with spilled powder or liquid in the laundry area.

One attempt to overcome the disadvantages of measuring out detergents was the use of a detergent pouch that was held together with a water soluble adhesive. An example of such a pouch is disclosed in U.S. Pat. No. 5,110,640. In theory, the pouch was designed to become unglued in the wash water and release detergent chemicals into the washing machine. However, the detergent chemicals in the pouch sometimes formed clumps that would not break or solubilize to release detergent into the wash water. Also, residual detergent chemicals could remain on the clothes if the detergents in the pouch formed insoluble clumps.

Another attempt in overcoming the problems of measuring detergents from containers has been the use of tablets containing laundry detergent. An example of such tablets is disclosed in U.S. Pat. No. 6,599,871. These tablets have the drawback of limited solubility in the wash water due to the low surface area for solubilization.

Yet another attempt to overcome the problems of measuring detergents from containers is disclosed in U.S. Pat. No. 6,864,196. There, substrate sheets containing detergent formulations that rely primarily on surfactants to reduce the surface tension of the detergent/wash water mixture, allowing the detergent/wash water mixture to spread across or penetrate more easily the surface of the articles in the wash water are used. Foamy surfactants can create a residue of unrinsed surfactants remaining on the clothes. As a result, the clothes may not be as clean as possible because of any residue left behind by a traditional laundry cleaning agent.

Moreover, the process involved in U.S. Pat. No. 6,864,196 in making the sheets requires that the components be stirred together to produce a homogeneous slurry. Once the slurry is formed, in order to apply the slurry to the substrate sheet to make the laundry sheet, the slurry must be pumped into a coating trough or other application device and impregnated or applied into or on the substrate sheet. The sheet must be supported in a horizontal and flat position while the water is evaporated from the sheet. The sheet must then be cut into desired shapes and sizes and placed in a box for use by the consumer.

Finally, traditional laundry detergents may have an adverse impact on the environment. Both powered and liquid detergents often incorporate fillers to make them flowable. The ingredients and byproducts of traditional laundry methods often must be processed by waste treatment plants and landfills.

Accordingly, a need exists for a more flexible laundry cleaning delivery system that is easy to produce, efficiently cleans clothes, minimizes the mess associated with traditional powder or liquid detergents, minimizes residue on clothes and minimizes any adverse impact on the environment.

### SUMMARY OF THE INVENTION

The invention is directed to a new and improved laundry cleaning delivery system that satisfies this need. The invention replaces traditional laundry detergent with a unique delivery system that dispenses cleaning liquid into laundry machines. The invention works by impregnating a cleaning solution into a sheet that has a substrate sufficient to contain the correct amount of cleaning solution to clean a particular load of laundry.

An embodiment of the invention relates to a laundry cleaning delivery system comprising a fabric substrate and a cleaning solution infused into the fabric substrate up to the saturation point of the fabric substrate. Preferably, the fabric substrate comprises hydraulically entangled nonwoven fibrous material. Preferably, the fabric substrate is periodically perforated to create sheets. Preferably, the fabric substrate is wound into rolls and the rolls are placed into containers. Preferably, the containers are resealable.

In one embodiment, the active ingredients of the cleaning solution preferably comprise amyl acetate and alcohol etoxylate. In another embodiment, other ingredients may include at least one component chosen from a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.

Another embodiment of the invention relates to a method of using a laundry cleaning delivery system comprising the steps of removing a length of fabric substrate infused with a cleaning solution up to the saturation point of the fabric substrate via a re-sealable opening in a container, placing the length of fabric substrate infused with a cleaning solution up to the saturation point of the fabric substrate into a load of laundry in a washing machine and washing the load of laundry in the washing machine. Preferably, the fabric substrate comprises hydraulically entangled nonwoven fibrous material. Preferably, the fabric substrate is periodically perforated to create sheets. Preferably, the fabric substrate is wound into rolls and the rolls are placed into containers. Preferably, the containers are resealable.

In another embodiment relating to a method of using a laundry cleaning delivery system, the active ingredients of the cleaning solution preferably comprise amyl acetate and alcohol etoxylate. In another embodiment relating to a method of using a laundry cleaning delivery system, the cleaning solution further comprise at least one component chosen from a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.

Yet another embodiment relating to a method of using a laundry cleaning delivery system further comprises adding traditional laundry detergent to the washing machine. Another embodiment relating to a method of using a laundry cleaning delivery system further comprises rubbing a stain on an article to be laundered with a sheet of a fabric substrate infused with a cleaning solution up to the saturation point of the fabric substrate until the stain is thoroughly saturated and starts to break up.

Another embodiment of the invention relates to a method of using a laundry cleaning delivery system comprising the steps of removing at least one sheet of a fabric substrate infused with a cleaning solution up to the saturation point of the fabric substrate via a re-sealable opening in a container, rubbing a stain on an article to be laundered with a sheet of a fabric substrate infused with a cleaning solution up to the saturation point of the fabric substrate until the stain is thoroughly saturated and starts to break up and then laundering the article by hand washing in a bowl, sink, tub or other container.

Another embodiment of the invention relates to a method of manufacturing a laundry cleaning delivery system comprising the steps of providing a fabric substrate, placing the fabric substrate into a container, infusing a cleaning solution into the fabric substrate up to the saturation point of the fabric substrate and sealing the container. Preferably, the fabric substrate comprises hydraulically entangled nonwoven fibrous material. Preferably, the fabric substrate is periodically perforated to create sheets. Preferably, the fabric substrate is wound into rolls. Preferably, the container is resealable.

In another embodiment of the invention relating to a method of manufacturing a laundry cleaning delivery system, the active ingredients of the cleaning solution preferably comprise amyl acetate and alcohol etoxylate. In another embodiment, other ingredients may include at least one component chosen from a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.

As will be realized, this invention is capable of other and different embodiments, and its details are capable of modifications in various obvious respects, all without departing from the invention. Accordingly, the descriptions are to be regarded as illustrative in nature and not restrictive.

### DETAILED DESCRIPTION OF THE INVENTION

In one embodiment of the invention, a fabric substrate is periodically perforated to create sheets of a desired size and roll count. A preferable material for the fabric substrate may be a hydraulically entangled nonwoven fibrous material, such as SONTARA 8005, a spunlaced fabric of 100% polyester with a nominal thickness of 22 mils, manufactured by DuPont Nonwovens, Sontara Technologies, Old Hickory, Tenn. The fabric substrate is wound into rolls and the rolls are placed into containers that are then placed into a liquid feeder tray.

The containers with the fabric substrate then proceed to a liquid fill station to receive a pre-determined amount of liquid cleaning solution. A suitable cleaning solution is preferably infused into the substrate up to the saturation point of the substrate. In other words, there is just enough cleaning solution to reach the point at which no more liquid can be absorbed by the substrate. The amount of cleaning solution required to reach the saturation point of the substrate varies based on the characteristics of the cleaning solution and the characteristics of the substrate, both of which persons skilled in this art are familiar with.

A preferred cleaning solution may be one where the active ingredients comprise amyl acetate, an organic compound also known as banana oil, and alcohol etoxylate. An example of a suitable cleaning solution is STAINZ-R-OUT by EXI International Corporation. A suitable cleaning solution preferably hydrolyzes, or breaks down, large stain molecules into small ones. The small molecules then mix with water and may be removed from the article to be cleaned. Similarly, a suitable cleaning solution can contain a small amount of a surfactant substance, examples of which are known to those skilled in the art. A suitable cleaning solution can also be biodegradable and non-toxic.

In one embodiment, when using STAINZ-R-OUT cleaning solution and SONTARA 8005 substrate, approximately 295 grams of cleaning solution are required to saturate fabric substrate sufficient for approximately 25 9″×7″ sheets, which corresponds to approximately 11 ounces of substrate material.

Following the addition of the cleaning solution used to infuse the fabric substrate, the containers are sealed and labeled. To use the product, sheets can be individually removed via a re-sealable opening in the container. A length of the fabric substrate corresponding to a desired sheet length is removed via an opening in the container. That action also draws up the next length of fabric substrate corresponding to a sheet. This process can continue until all the sheets are pulled up or removed from the container.

Another embodiment is a method of using a laundry cleaning delivery system. The method includes placing at least one of the sheets impregnated with cleaning solution into a small- to medium-size load of laundry in a washing machine, or placing a plurality of sheets into a larger load of laundry in a washing machine instead of using other soap or detergent. The laundry is then washed as usual.

An alternative method includes placing one or more sheets impregnated with cleaning solution into a load of laundry to enhance the cleaning power of a traditional laundry detergent. The laundry is then washed as usual.

Yet another method includes rubbing a stain on an article to be laundered with a sheet impregnated with cleaning solution until the stain is thoroughly saturated and starts to break up. This method further comprises washing the stained article as usual. Alternatively, the stained article, after having a stain on the article treated as described above, can be laundered by other methods, such as by hand washing in a bowl, sink, tub or other container.

One advantage of this cleaning system and method includes convenience. Users of this cleaning method need not measure traditional powder or liquid to wash clothes. There may be no mess with spilled powder or liquid in the laundry area. Also, the cleaning solution does not need to rely primarily on surfactants to be effective. This reduces residue of unrinsed surfactants remaining in the clothes. Clothes are cleaner and contain less, if any, residue than that left behind by a traditional laundry cleaning agent. Finally, the environmental impact of this product is far less than traditional laundry detergents. For example, the laundry sheets may be recycled.

Although the invention has been described in considerable detail, other alternative versions are possible. Alternate embodiments of the laundry cleaning delivery system may include different sheet fabrics, sizes and types scaled to accommodate different laundry machines or load sizes. This may increase or decrease the amount of cleaning agent contained in each sheet.

Alternate embodiments of the laundry cleaning delivery system may also include different cleaning agents. If different cleaning agents, including cleaning agents containing surfactants, or any cleaning agent for a desired cleaning task are used, the substrate of the sheet may be adjusted to hold the correct amount of cleaning agent based on that cleaning solution.

Alternate embodiments of the laundry cleaning delivery system may also include different types and shapes of containers and different types and shapes of openings in the container through which the sheets are withdrawn from the container.

As optional components, alternate embodiments of the laundry cleaning delivery system may also include, in any combination, builders, complexing agents, surfactants, optical brighteners, oxidizing agents, alkaline sources, electrolytes, foam stabilizers, fragrances, color enhancers, biocides, corrosion inhibitors, soil anti-redeposition agents, encrustation preventers, enzymes for stain removal, anti-static conditioners and fabric softeners. Any one or more of these components can be present and examples of each of these components are known to those skilled in the art.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing form the spirit and scope of the invention. Thus, this invention is not intended to be limited to the embodiments shown, but is to be accorded the widest scope consistent with the principles and features disclosed herein.

What is claimed is:

1. A laundry cleaning delivery system, comprising:
a fabric substrate, and
a cleaning solution infused into the fabric substrate up to the saturation point of the fabric substrate.

2. The laundry cleaning delivery system according to claim 1, wherein the fabric substrate comprises hydraulically entangled nonwoven fibrous material.

3. The laundry cleaning delivery system according to claim 1, wherein the fabric substrate is periodically perforated to create sheets.

4. The laundry cleaning delivery system according to claim 1, wherein the fabric substrate is wound into rolls and the rolls are placed into containers.

5. The laundry cleaning delivery system according to claim 4, wherein the containers are resealable.

6. The laundry cleaning delivery system according to claim 1, wherein the active ingredients of the cleaning solution comprise amyl acetate and alcohol etoxylate.

7. The laundry cleaning delivery system according to claim 1, further comprising at least one component selected from the group consisting of a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.

8. A method of using a laundry cleaning delivery system, comprising:
removing a length of fabric substrate infused with a cleaning solution up to the saturation point of the fabric substrate via a re-sealable opening in a container;
placing the length of fabric substrate infused with a cleaning solution up to the saturation point of the fabric substrate into a load of laundry in a washing machine; and
then washing the load of laundry in the washing machine.

9. The method of claim 8, wherein the fabric substrate comprises hydraulically entangled nonwoven fibrous material.

10. The method of claim 8, wherein the fabric substrate is periodically perforated to create sheets.

11. The method of claim 8, wherein the fabric substrate is wound into rolls and the rolls are placed into containers.

12. The method of claim 11, wherein the containers are resealable.

13. The method of claim 8, wherein the active ingredients of the cleaning solution comprise amyl acetate and alcohol etoxylate.

14. The method of claim 8 wherein the cleaning solution further comprises at least one component selected from the group consisting of a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.

15. The method of claim 8, further comprising adding traditional laundry detergent to the washing machine.

16. The method of claim 8, further comprising rubbing a stain on an article to be laundered with a sheet of a fabric substrate infused with a cleaning solution up to the saturation point of the fabric substrate until the stain is thoroughly saturated and starts to break up.

17. A method of using a laundry cleaning delivery system, comprising:
removing at least one sheet of a fabric substrate infused with a cleaning solution up to the saturation point of the fabric substrate via a re-sealable opening in a container;
rubbing a stain on an article to be laundered with a sheet of a fabric substrate infused with a cleaning solution up to the saturation point of the fabric substrate until the stain is thoroughly saturated and starts to break up; and
then laundering the article by hand washing in a bowl, sink, tub or other container.

18. A method of manufacturing a laundry cleaning delivery system, comprising:
providing a fabric substrate;
placing the fabric substrate into a container;
infusing a cleaning solution into the fabric substrate up to the saturation point of the fabric substrate; and sealing the container.

19. The method of claim 18, wherein the fabric substrate comprises hydraulically entangled nonwoven fibrous material.

20. The method of claim 18, wherein the fabric substrate is periodically perforated to create sheets.

21. The method of claim 18, wherein the fabric substrate is wound into rolls.

22. The method of claim 18, wherein the container is resealable.

23. The method of claim 18, wherein the active ingredients of the cleaning solution comprise amyl acetate and alcohol etoxylate.

24. The method of claim 18 wherein the cleaning solution further comprise at least one component selected from the group consisting of a builder, a complexing agent, a surfactant, an optical brightener, an oxidizing agent, an alkaline source, an electrolyte, a foam stabilizer, a fragrance, a color enhancer, a biocide, a corrosion inhibitor, a soil anti-redeposition agent, an encrustation preventer, an enzyme for stain removal, an anti-static conditioner and a fabric softener.
